(19) United States
(12) Patent Application Publication
(10) Pub. No.: US 2026/0081800 A1
(43) Pub. Date: Mar. 19, 2026

(54) PROVIDING MICROSERVICES USING VIRTUAL AGENTS FOR VIDEO CONFERENCING APPLICATIONS AND SYSTEMS

(71) Applicant: NVIDIA Corporation, Santa Clara, CA (US)

(72) Inventors: Aurobinda MAHARANA, Pune (IN); Vignesh UNGRAPALLI, Bengaluru (IN); Ambrish DANTREY, Pune (IN); Abhijit PATAIT, Pune (IN); Nitin Mahesh GODE, Maharashtra (IN); Vishal Bhaskar CHILUKA, Mumbai (IN); Lalit Kumar BEGANI, Bengaluru (IN)

(21) Appl. No.: 18/890,008

(22) Filed: Sep. 19, 2024

(51) Int. Cl. H04L 12/18

(52) U.S. Cl. CPC H04L 12/1813

(57) ABSTRACT

In various examples, virtual participant-based microservices for video conferencing applications and systems are provided. A virtual participant service provides a subject matter expert to participants of a conference session. A virtual participant may be presented within a video conferencing environment as a simulated meeting participant that other meeting participants may interact with using natural conversational language. The virtual participant service may include a virtual participant controller frontend service that interfaces with the video conferencing platform, an avatar manager to generate an avatar representing the virtual participant, and an LLM services gateway that functions as a microservices server for one or more LLM-based services that may be accessed through the virtual participant. The virtual participant service may use natural language processing to evaluate spoken requests for information and provide a response back to the human user participants of the conference channel using an animated avatar.

### BACKGROUND

Modern video conferencing platforms in the art today (e.g., Microsoft Teams, Zoom, Cisco Webex, GoToMeeting, etc.) operate by combining different technologies that facilitate real-time communication and collaboration between meeting attendees. For example, these platforms may use Voice over Internet Protocol (VOIP) and video data using codecs to transmit audio and video over one or more networks (e.g., the Internet and/or other public and private networks) by converting analog voice and video image signals into digital data packets, which are then transmitted over the network(s). Collaboration may be further enhanced by the use of application programming interfaces (APIs) (e.g., application add-ons or plug-ins) that integrate various software components and enable services and features for conference participants such as screen sharing, file sharing, and interactive whiteboards. Video conferencing systems are often implemented using cloud computing platforms to provide a backend infrastructure for data storage, scalability, and to provide access to a conference across a plurality of user devices.

### SUMMARY

Embodiments of the present disclosure relate to virtual participant-based microservices for video conferencing applications and systems.

In contrast to existing video conferencing platforms, one or more of the embodiments described herein establish a virtual participant service that may function as a subject matter expert to participants of a video conferencing session. A virtual participant may be presented within the video conferencing session as a simulated meeting participant that other meeting participants may interact with using natural conversational language. The virtual participant may monitor the audio and/or video data transmitted during the session (e.g., over a communication channel used to transport meeting content between meeting participants). In some embodiments, the virtual participant may further monitor communications over the communication channel. The virtual participant may respond to questions and/or queries by transmitting audio and/or video data to the communication channel so that it may be presented to the meeting participants during or after the session. In some embodiments, the virtual participant is presented as a simulation of a participant within the video conferencing session in the same manner as other participants, with a synthesized audio and video feed presenting an animated avatar that speaks in the same way that other participants provide an audio-video feed during the conference session.

The virtual participant service may include a virtual participant controller (VPC)—a frontend to the virtual participant service that interfaces with the video conferencing platform. The virtual participant service may include a large language model (LLM) platform-a backend to the virtual participant service that includes an avatar manager (to instantiate and control an avatar representing the virtual participant) and an LLM services gateway (that functions as a microservices server for one or more LLM-based services that may be accessed through the virtual participant). To expose the virtual participant to the other user participants of a conference session, the VPC may establish a communication channel. The plug-in and/or other applications may be programmed to permit the video conferencing platform to access a network address (e.g., a uniform resource locator, (URL)) that points to the VPC, in order to establish the communication channel between the conference session and the VPC. By interacting with the virtual participant, human user attendees participating in the conference session can use the virtual participant as a subject matter expert by submitting requests or instructions to the virtual participant to evaluate, answer questions and/or provide reports based on relevant documents provided to the virtual participant (e.g., through the communication channel), and/or research and report on information from one or more other data sources available to the virtual participant. The virtual participant service may use natural language processing to evaluate spoken requests (queries) for information, retrieve and/or evaluate data from one or more data sources based on the request, and provide a response back to the human user participants of the conference session using an animated avatar to present the results as simulated speech, and/or may present a response using voice, image, video, and/or text formats, or any combination thereof. In this way, the virtual participant service effectively implements a platform that simulates a virtual agent within the conference session that has access to one or more data sources from which it can generate authoritative responses to queries from the human user participants.

### BRIEF DESCRIPTION OF THE DRAWINGS

The present systems and methods for virtual participant-based microservices for video conferencing applications and systems are described in detail below with reference to the attached drawing figures, wherein:

FIG. 1 is an example data flow diagram for a process for a virtual participant service system, in accordance with some embodiments of the present disclosure;

FIG. 2A is a diagram that illustrates an avatar manager for a virtual participant service, according to some embodiments of the present disclosure;

FIG. 2B is a diagram that illustrates an example backend large language model (LLM) platform for a virtual participant service, according to some embodiments of the present disclosure;

FIG. 3 is a diagram illustrating an example user interface of a user participant client application representing a video conferencing environment that includes a virtual participant, according to some embodiments of the present disclosure;

FIGS. 4A and 4B are diagrams illustrating example user interfaces (UIs) for activating, configuring, and/or using aspects of the virtual participant from within the video conferencing environment, according to some embodiments of the present disclosure;

FIG. 5 is a diagram illustrating a method for a virtual participant service, in accordance with some embodiments of the present disclosure;

FIG. 6 is a block diagram of an example computing device suitable for use in implementing some embodiments of the present disclosure; and

FIG. 7 is a block diagram of an example data center suitable for use in implementing some embodiments of the present disclosure.

### DETAILED DESCRIPTION

Systems and methods are disclosed related to virtual participant-based microservices for video conferencing applications and systems. More specifically, one or more embodiments include a virtual participant service that generates an avatar-based virtual subject matter expert as a service to users participating in a conference session within a video conferencing environment.

Video conferencing platforms are often used to facilitate a collaborative environment similar in experience to an in-person meeting. Screen sharing and virtual whiteboards are examples of particularly useful video conferencing features that allow meeting participants to share presentations, documents, or any other visual content that may be presented by a participant in real-time. Screen sharing, for example, permits one of the meeting participants to act as a host for the purpose of sharing content displayed on their local workstation. However, screen sharing is often an awkward endeavor for the host as they attempt to locate and open the desired contents and juggle between screens and/or windows so that the intended content (and just the intended content) is displayed to the other participants of the conference session. In many instances, different meeting participants have access to different documents, which necessitates one user having to relinquish the hosting of screen sharing so that a different user can assume that role and begin screen sharing the content available on their local workstation.

In present day video conferencing platforms, moreover, using shared documents has limited usefulness, as conference participants may be hindered by the inability to quickly locate and present particular information (which may be spread across one or more lengthy documents) that may be relevant to the present discussion. Manipulating content, evaluating content, and/or switching screen sharing hosts routinely causes pauses and/or delays to the flow a meeting, which can interrupt thought-flows and bring challenges with respect to adhering to pre-set meeting durations and schedules. Since establishing and operating a conference session within a video conferencing platform consumes energy and processing resources (e.g., in terms of compute and memory), an inefficient use of meeting time directly implicates an inefficient use of the underlying computing resources that establish the conference session.

In contrast to existing video conferencing platforms, one or more of the embodiments described herein establish a virtual participant service that may function as a subject matter expert to other participants of a conference session. A virtual participant may be presented within the conference session as a simulated meeting participant that other meeting participants may interact with using natural conversational language. The virtual participant may monitor the audio and/or video data transmitted over a communication channel used to transport meeting content between meeting participants during the conference session. In some embodiments, the virtual participant may further monitor text communications (e.g., text-based “chat” communications from meeting participants) transmitted over the communication channel. As described in greater detail below, the virtual participant may respond to questions and/or queries by transmitting audio and/or video data during the conference session over the communication channel so that it may be presented to the meeting participants. In some embodiments, the virtual participant is presented as a simulation of a participant within the conference session in the same manner as other participants, with a synthesized audio and video feed presenting an animated avatar that speaks during the conference session in the same way (e.g., via a communication channel) that other participants provide an audio-video feed during the conference session.

In some embodiments, the virtual participant service may be implemented using one or more nodes (e.g., servers) of a cloud-based computing platform. The virtual participant service may include a virtual participant controller (VPC)—a frontend to the virtual participant service that interfaces with the video conferencing platform. The virtual participant service may include a large language model (LLM) platform-a backend to the virtual participant service that includes an avatar manager (to instantiate and control an avatar representing the virtual participant) and an LLM services gateway (that functions as a microservices server for one or more LLM-based services that may be accessed through the virtual participant).

To expose the virtual participant to the other user participants of a conference session, the VPC may join or establish a communication channel with the conference session. The communication channel defines the logical infrastructure established by the video conferencing platform that carries audio, video, and/or text communications between a plurality of user participants (or more specifically the user participant's conference client applications) within the context of a conference session. For example, the video conferencing platform may execute a plug-in and/or other application that establishes an interface (e.g., an API) providing access to the conference session such that the VPC may receive communication channel data (audio, video, and/or text) transported between user participants from the conference session, and transmit data (audio, video, and/or text) over the communication channel for reception by user participants of the conference session.

The plug-in, APO, and/or other application may be programmed to permit the video conferencing platform to access a network address (e.g., a URL) that points to the VPC in order to establish the communications channel between the conference session and the VPC. In some embodiments, the VPC may execute one or more client applications (e.g., a hypertext transfer protocol (HTTP) client for a control channel and/or a WebRTC sender and receiver client for audio, video, and/or text data) that use the interface with the video conferencing platform to instantiate the virtual participant as a meeting participant to the conference session. For example, in some embodiments, the VPC may access a Microsoft Graph API to obtain access to the communication channel of a conference session hosted by a video conferencing application so that the virtual participant provided by the VPC is able to receive and send audio, video, and/or text data as any human user participant would be able to do over the communication channel. In some embodiments, communications between the VPC and the video conferencing platform may use RTC channels, HTTP, general-purpose Remote Procedure Call (gRPC), representational state transfer (REST), Microsoft BOT, or other framework or protocol.

By interacting with the virtual participant, human user participants in the conference session can use the virtual participant as a subject matter expert by instructing or requesting the virtual participant to evaluate, answer questions, and/or provide reports based on relevant documents provided to the virtual participant, and/or research and report on information from one or more other data sources available to the virtual participant. The virtual participant service may use natural language processing to evaluate spoken request (queries) for information, retrieve and/or evaluate data from one or more data sources based on the request, and provide a response back to the human user participants of the conference session using an animated avatar to present the results as simulated speech, and/or may present a response using voice, image, and/or text formats, or any combination thereof. In some embodiments, the VPC may transmit the response to the conference session as an animated avatar that is presented onto the user interfaces of human user participants as a simulated participant video feed in the same or similar way that other participant video feeds are displayed. As such, the human user participants may interact and/or interface with the virtual participant in the same conversational manner that they do with other human user participants on the conference session. In this way, the virtual participant service effectively implements a platform that simulates within the conference session a participant that has access to one or more data sources from which it can generate authoritative responses to queries from the human user participants.

In some embodiments, the responses to queries from the human user participants are generated by the backend large language model (LLM) platform of the virtual participant service. The responses may be generated using one or more LLM-based resources, referred to herein as microservices, that are exposed by the virtual participant service via the VPC. For example, in some embodiments, LLM-based microservices comprise independent services that communicate with the virtual participant service based on service calls over application programming interfaces (APIs).

LLM-based microservices may include services that summarize, compile, critique, compare, or otherwise evaluate information from one or more data sources based on queries from a user participant. For example, the LLM services gateway may call on the services of one or more LLM models to respond to a query that may be presented to the LLM models as one or more prompts. LLM models generate a response in a natural language format that may be used to communicate information back to the conference channel via the VPC.

In some embodiments, LLM service gateways may access one or more LLM-based retrieval-augmented generation (RAG) artificial intelligence models. A RAG may access one or more data sources as authoritative knowledge to augment training-based data sources when generating responses to input prompts in order to extend a general LLM's abilities to one or more specific domains. Data sources may include, but are not limited to, authoritative documents uploaded to the RAG and/or data from network-connected servers. For example, a user participant may instruct the virtual participant to upload one or more documents to a RAG available through the LLM services gateway access, and/or upload a link pointing to one or more documents that the RAG may access. The documents may include specialized information, knowledge, data, facts, reports, contracts, intelligence, and/or other content that may be used by the virtual participant service to generate responses having a greater degree of relevance, accuracy, depth, and/or detail than responses generated by general LLM models. That is, based on queries directed to the virtual participant in attendance on the conference channel, a RAG function may generate responses using a specified knowledge base made accessible to the RAG function. For example, to prepare the virtual participant to be an authoritative expert in a field of biology, the RAG function may be provided access to a library of trusted documents (e.g., peer-reviewed articles, trusted texts, treatises, proprietary documents, etc.) that it uses as a knowledge base from which to select the most relevant documents to generate natural language responses to biology-related queries.

With respect to summarizing content, the LLM-based microservices may include one or more summarization services for summarizing content such as, but not limited to, documents, video content, whiteboard content, website content and/or other materials provided through the conference channel. In some embodiments, summarization services may be requested by directing spoken requests and/or chat message requests to the virtual participant. In some embodiments, summarization services may be requested by activating a summarization request control displayed on a user interface to one or more of the user participants. In one or more embodiments, summarizations may be displayed back to a chat (e.g., text messaging) window, and/or accessible as downloadable documents from a link displayed to the chat window. In some embodiments, the summary results may be sent to the avatar manager to generate an animated avatar presentation of the results (or portion thereof) for presentation by the virtual participant.

For example, with respect to document summarizing, the VPC may receive a request from the conference channel to summarize a document. In some instances, the document may have been previously uploaded to a memory of the LLM services gateway. For example, user participants may instruct the virtual participant to upload one or more documents. The VPC, in response to a request to the virtual participant, may upload the documents from a user participant's workstation or from a network source specified by the request (e.g., a network link entered into the conference chat function) and store that document into the memory of the LLM services gateway. In some embodiments, the specified network source may be a website, in which case the document summarization may provide a summary of content served from that website. Upon receiving a document summarization request, the LLM services gateway may activate, for example, an artificial intelligence-based document summarizer model trained to distill text and/or images (from specified documents from the memory) into concise summaries (e.g., main points and/or key information).

With respect to whiteboard summarizing, the VPC may receive a request from the conference session to summarize an image, for example, produced by a whiteboard feature and/or an image displayed during the conference session via screen sharing. In some instances, such an image may be captured from the conference session by the VPC, and stored to a memory of the LLM services gateway. Upon receiving an image summarization request, the LLM services gateway may activate, for example, an artificial intelligence-based image-to-text summarizer model trained to understand image content. The LLM services gateway may input the image to the image-to-text summarizer model as a prompt to analyze the image, and generate a textual description of the image.

With respect to meeting summarization, the VPC may receive a request from the conference session to summarize the conversation between conference participants (e.g., including the user participants and/or results presented by the virtual participant). The summarization may comprise a summarization of the entire duration of the conference, or just a specified segment of the conference. In some embodiments, the VPC may ingest incoming communication channel data and store that data to a memory of the LLM services gateway. Upon receiving a meeting summarization request, the LLM services gateway may activate, for example, an artificial intelligence-based audio (speech)-to-text summarizer model trained to understand audio content and distill conversations into concise textual summaries (e.g., main points and/or key information). In some embodiments, an audio-to-text summarizer model may produce a set of meeting minutes based on the VPC monitoring of the conference session.

In some embodiments, the LLM services gateway may be configurable, as further discussed below, to offer customizable sets of microservices that may be accessed from within a conference session via the interactions with the virtual participant. For example, the LLM services gateway may be configurable to specify which LLM models (e.g., NVIDIA NeMo, Meta Llama, OpenAI ChatGPT, etc.) and/or RAG models (e.g., Chatlabs RAG, or other third-party RAG models) are used to generate responses, or to connect other endpoints offering other microservices. The LLM services gateway may execute rule-based logic or other algorithms to determine which one or more of the LLM, RAG, or other microservices are called on to provide information for constructing the response to a query.

In some embodiments, the VPC may implement an invocation mechanism to determine when the virtual participant responds to incoming data. For example, the VPC may monitor audio data for a predetermined (and/or configurable) keyword or key phrase and wake to process incoming data during the conference session based on a user participant speaking the keyword or key phrase. In other modes, the VPC may be configured to continuously process incoming data during the conference session without being triggered by a keyword or key phrase. In such embodiments, the VPC may monitor for requests directed to the virtual participant. In some embodiments, the video conferencing environment (e.g., user interface) of the conference session may include a text-based chat window, where the VPC may monitor for the keyword or key phrase in text messages broadcast to participants, and/or in response to a direct chat message sent to the virtual participant. In some embodiments, the user interface (UI) for user participants to access the conference session may include a user control that can be activated by users as an invocation mechanism so that the VPC is triggered to process incoming data during the conference session and/or received over the communication channel based on a user's activation of the user control.

In some embodiments, the VPC routes incoming communication channel data through the avatar manager to produce the interactive experience with the virtual participant for other user participants. That is, the avatar manager implements an interactive avatar that perceives information from user participants based on audio and image feeds of the user participants during the conference session and communicated over the communication channel, and intelligently converses with the user participant through the virtual participant to answer questions and provide recommendations, summaries, and analyses by making LLM calls to the LLM services gateway. The LLM services gateway may comprise a REST API that exposes the microservice offerings of the LLM services gateway. In some embodiments, LLM calls to the LLM services gateway and the resulting responses may be performed, for example, via an HTTP-based API. That is, while in some embodiments, the avatar manager and LLM services gateway may be integrated together on a common computing platform, in some embodiments they may be implemented on distinct network nodes (e.g., servers) connected via one or more networks. Similarly, the avatar manager may be implemented on a network node distinct from the VPC and connected via one or more networks. For example, the avatar manager may use HTTP protocols for a control channel with the VPC (e.g., for controlling the flow of incoming or outgoing communication channel data, or to communicate other overhead data), a first WebRTC protocol channel for receiving audio and/or video from the conference channel, and/or a second WebRTC protocol channel for sending animated avatar data (audio and video) for rendering the virtual participant as an interactive animated avatar within the video conference session. However, embodiments are not limited to these protocols, and in some embodiments other protocols may be used to communicate data between the VPC, avatar manager, and LLM services gateway.

In some embodiments, the avatar manager may be implemented using an artificial intelligence (AI)-based software framework (e.g., a suite of cloud-hosted AI models) such as, but not limited to, NVIDIA's Tokkio. In some embodiments, the avatar manager may comprise a first communication channel-processing path to process incoming communication channel data received via the VPC. In some embodiments, the avatar manager may comprise a second communication channel-processing path to process outgoing communication channel data for presentation to the conference session via the VPC.

In some embodiments, the first communication channel-processing path for processing incoming communication channel data may include an automatic speech recognition (ASR) software module that operates together with a dialogue manager (DM) software module and/or natural language processing AI. For example, the ASR may be implemented using NVIDIA Riva. In some embodiments, the DM may be implemented using a Rasa dialog management framework. The DM comprises algorithms and AI for natural language understanding to engage in interactive dialogue with the human user participants. In some embodiments, the ASR may be implemented using a set of graphics processing unit (GPU)—accelerated multilingual speech and translation microservices that include speech-to-text and neural machine translation services to produce prompts used to interface with the LLM(s) and/or RAG(s) accessible from the LLM services gateway. Based on the audio and/or video feeds of the human user participants received during the conference session via the communication channel, the avatar manager processes the incoming communication channel data to infer queries and/or other requests and prepare prompts that are sent to the LLM services gateway for routing to the LLM(s), RAG(s), and/or other microservice depending on the nature of the query.

In some embodiments, the second communication channel-processing path is for processing outgoing communication channel data that may include responses to queries received back from the LLM services gateway that are to be presented by the animated avatar for the virtual participant. The second communication channel-processing path may include, for example, a text-to-speech (TTS) module, an audio-to-face (A2F) module, and/or a video management service (VMS) module. For example, a response from the LLM services gateway may be received in the form of text. The TTS may comprise algorithms and AI to convert the text into spoken audio using an AI model-generated voice. The TTS-generated voice audio may then be fed to the A2F module to produce an animated three-dimensional (3D) avatar whose lips and/or other facial features are generated to match the voice-over track of the spoken audio from the TTS. In some embodiments, the A2F module may comprise or be implemented using the NVIDIA Audio2Face facial animation generative AI-based algorithms. The VMS may then transmit the resulting animation (e.g., as streaming video) for presentation during the conference session via the VPC. In some embodiments, presentation of the animated 3D avatar by the VMS may be controlled by the DM, for example to respond to incoming requests for the virtual participant to pause or stop a presentation, and/or to repeat a segment of the response.

Regarding configuration of the LLM services gateway, the virtual participant service may be instantiated with a default pre-configuration of which LLM(s), RAG(s), and/or other microservices are exposed and made available via interactions with the virtual participant. In some embodiments, the virtual participant may be added to a conference session through a UI control provided by the video conference platform. For example, the UI control may activate a plug-in or application that links the conference session to the VPC, as described above (to add the virtual participant to the conference session), and provides an interface for configuring one or more aspects of the virtual participant service. In some embodiments, the plug-in or application may provide a directory listing for the virtual participant service that a meeting organizer may use to select and invite the virtual participant to a conference session (e.g., similar to how other resources such as physical conference rooms may be reserved through invitations). As such, other participants may be able to see that the virtual participant has been invited. In some embodiments, the interface for configuring one or more aspects of the virtual participant service may include options (e.g., checkboxes, pull-down menus, fields for entering network addresses, etc.) for selecting a choice of one more LLM(s), RAG(s), and/or other microservices, and the LLM services gateway will connect to those selected services—and configure the LLM services gateway to fuse or otherwise combine responses when more than one of the selected resources are called to provide a response (e.g., using an LLM call to combine the multiple responses into a single coherent response).

Although configurations described above have focused on establishing a single virtual participant through the virtual participant service, in some embodiments, two or more virtual participants may be provided to a conference session. For example, a UI control may provide options to activate more than one plug-in or application that links to separate virtual participant service instances, each of which may comprise a VPC that establishes a conference session with a communication channel so that user participants may interact with both virtual participants. For example, the respective VPCs for the two (or more) virtual participants may configure their invocation mechanism with different keyword or key phrases so that user participants may direct their queries to a specific one of the virtual participants.

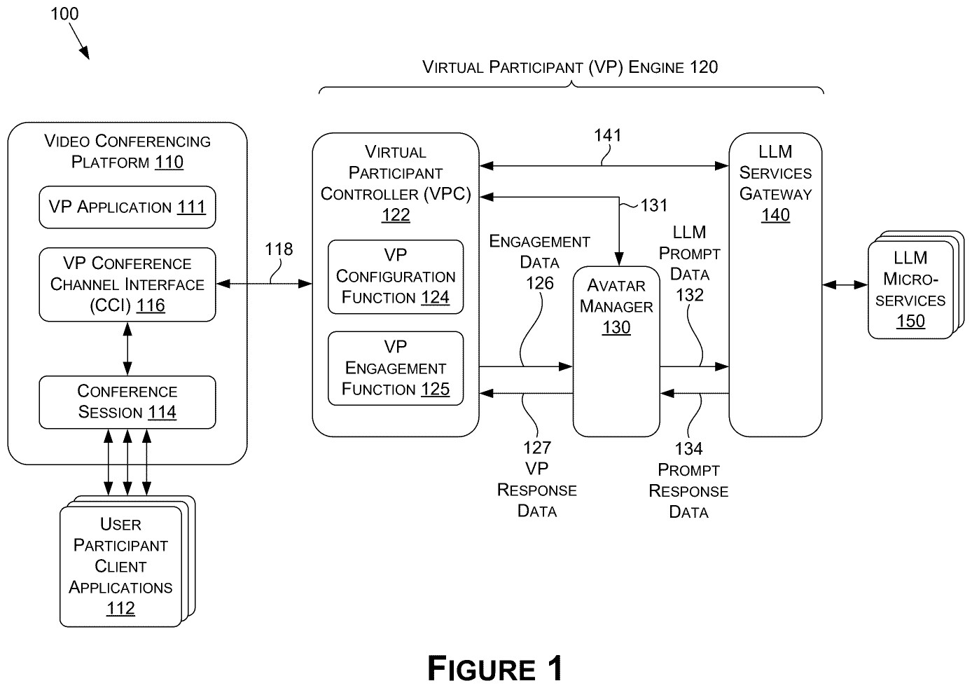

With reference to FIG. 1, FIG. 1 is an example data flow diagram for a process for a virtual participant service system 100, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

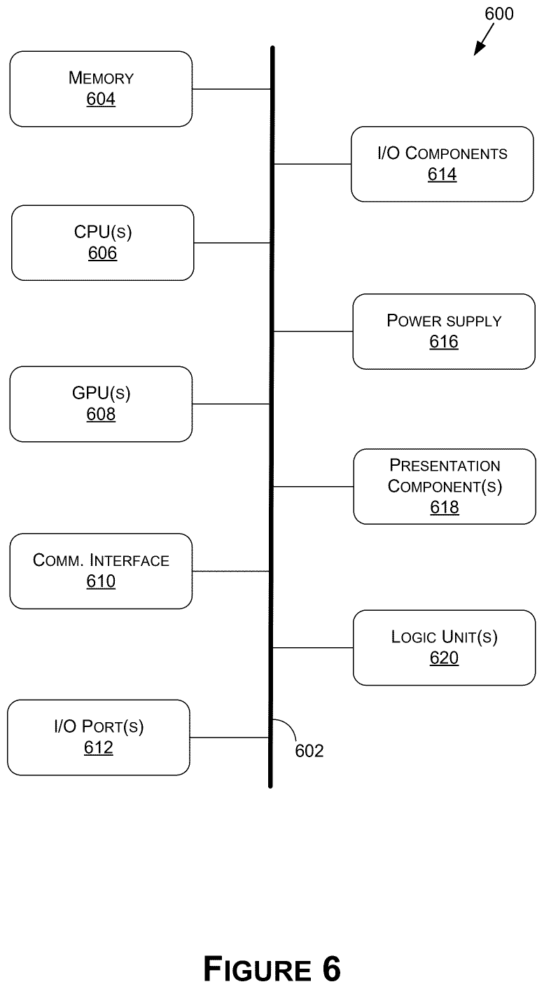

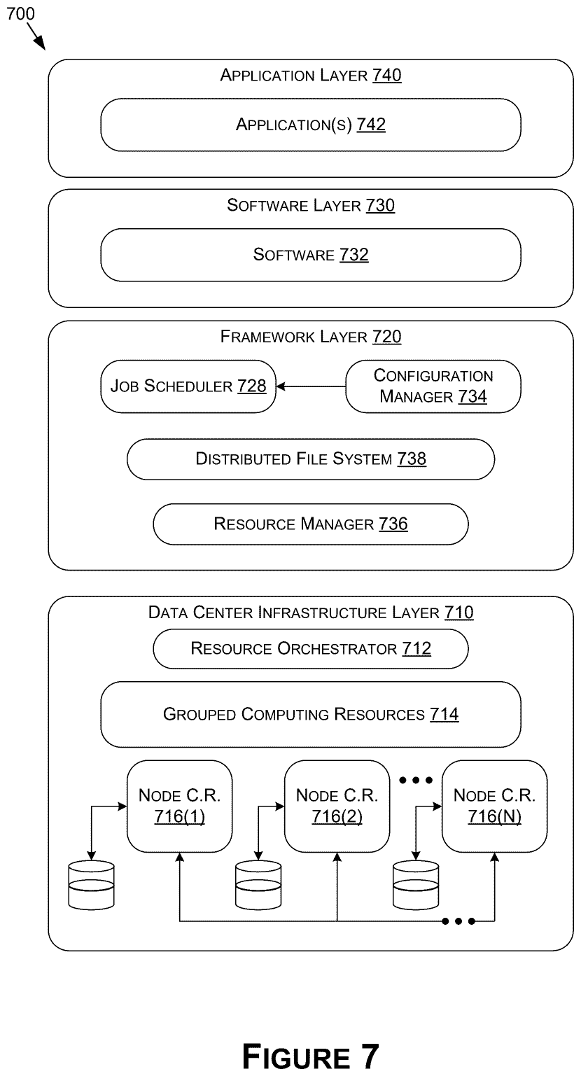

As shown in FIG. 1, the virtual participant service system 100 may comprise a virtual participant (VP) engine 120 that couples to a video conferencing platform 110 to instantiate a virtual participant as a service that is accessible within the context of a video conferencing meeting hosted by the video conferencing platform 110. In some embodiments, one or more functions and/or components of the virtual participant service system 100 described herein may be realized at least in part using a computing device, such as computing device 600 shown in FIG. 6, and/or resources of a data center, such as data center 700 described with respect to FIG. 7.

The video conferencing platform 110 may comprise a conferencing service such as, but not limited to, Microsoft Teams, Zoom, Cisco Webex, GoToMeeting, and the like. Generally, when the video conferencing platform 110 initiates a video conferencing meeting (e.g., a “call”) the video conferencing platform 110 may establish an instance of a conference session 114. The conference session 114 defines a shared logical infrastructure established by the video conferencing platform 110 that carries audio, video, text and/or other forms of communications via a communication channel between a plurality of user participants who are attendees to a video conferencing meeting. More specifically, a plurality of user participants (e.g., human users) may individually access the conference session 114 (e.g., via a networked connection) through their respective user participant client applications 112—which may be executed by the user participants using various computing device(s) (such as the computing device 600 shown in FIG. 6). The user participant client applications 112 may comprise, for example, a stand-alone video conferencing application (e.g., a Microsoft Teams application) or a web browser application (e.g., Microsoft Edge) that accesses the conference session 114 via a web server (HTTP) protocol.

In some embodiments, the VP engine 120 may establish a communication channel 118 with the conference session 114 through a VP conference channel interface (CCI) 116 provided by the video conferencing platform 110. For example, the video conferencing platform 110 may execute a VP application 111 that establishes the CCI 116 as an application programming interface (API) that provides access to the conference session 114, and a link established with the conference session 114. The communication channel 118 between the CCI and VP engine 120 may be implemented using one or more wired or wireless network communications links over a network such as the Internet, for example.

As shown in FIG. 1, in some embodiments the VP engine 120 may comprise a virtual participant controller (VPC) 122, an avatar manager 130, and an LLM services gateway 140 that is coupled to one or more LLM-based microservices 150. As discussed herein, the VP engine 120 exposes to and provides user participants of the conference session 114 with access to the LLM-based microservices 150 as a service through interactions with the virtual participant. In some embodiments, one or more of the LLM-based microservices 150 comprise independent services that communicate with the LLM services gateway 140 based on service calls over application programming interfaces (APIs). By interacting with the virtual participant, human user participants on the conference session 114 can use the virtual participant as a subject matter expert that can intelligently respond to natural language queries with responses generated based on the services made available by having access to the LLM-based microservices 150.

In some embodiments, the CCI 116 may be programmed or otherwise configured to access a network address (e.g., a URL) that points to the VPC 122 in order to establish the communication channel 118 between the conference session 114 and the VPC 122. Through the communication channel 118, the VPC 122 may monitor communication channel data (e.g., as incoming audio, video, and/or text) transported between user participants from the conference session 114. The VPC 122 may further contribute communication channel data (e.g., as outgoing audio, video, and/or text) into the conference session 114 from where it may be distributed to the user participant client applications 112 and presented to the user participants. The VPC 122 may comprise a VP configuration function 124 that establishes a control channel via the communication channel 118 (e.g., an HTTP channel) that may be used to instantiate, manage, and configure the virtual participant for use as a meeting participant to the conference session 114. For example, the VP configuration function 124 may communicate control data 141 with the LLM services gateway to configure one or more services and/or preferences-such as to select which LLM microservices 150 are exposed to the conference session 114 by the VP engine 120, or for uploading data sources for providing authoritative knowledge to the virtual participant. The VP configuration function 124 may communicate control data 131 with the avatar manager 130, for example, to configure language preference and/or voice and appearance preferences of the avatar representing the virtual participant within the conference channel. In some embodiments, the VPC 122 may comprise a VP engagement function 125 that recognizes when monitored communication channel data is received via the communication channel 118 that comprises invocations and/or queries to be answered by the virtual participant. In some embodiments, communications between the VPC 122 and the CCI may use RTC channels, HTTP, general-purpose Remote Procedure Call (gRPC), REST, Microsoft BOT, and/or another framework or protocol.

In some embodiments, the VP engagement function 125 includes, for example, a speak recognition algorithm to implement the invocation mechanism to determine when the virtual participant responds to incoming communication channel data from the conference session 114. For example, the VP engagement function 125 may monitor audio data for a predetermined keyword or key phrase (which may be configurable via the VP configuration function 124), wake to begin processing incoming communication channel data in response to a user participant speaking the keyword or key phrase, and route requests as engagement data 126 to the avatar manager 130. In other modes, the VP engagement function 125 may be configured to continuously process incoming communication channel data without being triggered by a keyword or key phrase. That is, the VP engagement function 125 may monitor the incoming communication channel data for requests directed to the virtual participant, and route those requests as engagement data 126 to the avatar manager 130. Responses from the avatar manager 130 are received by the VP engagement function 125 as VP response data 127, which may then be communicated to the conference session 114 in response to a query.

As described in greater detail below, the avatar manager 130 processes engagement data 126, which may include audio and image feeds from the user participants during the conference session 114, to generate LLM prompt data 132, which may be used for making LLM calls to the LLM services gateway 140 and prompt one or more responses from the LLM microservices 150. The responses from the LLM microservices 150 may be aggregated and/or otherwise synthesized together to form prompt response data 134 that is provided to the avatar manager 130. As described herein, the prompt response data 134 may include answers to questions, recommendations, summaries, analyses, and/or other evaluations performed by the LLM microservices 150 based on the LLM prompt data 132. Based on the prompt response data 134, the avatar manager 130 may produce the VP response data 127, which presents the prompt response data 134 in the form of a response from the virtual participant to the conference session 114 as voice and image data presented by an animated avatar and/or as a text message from the virtual participant to a conference chat window.

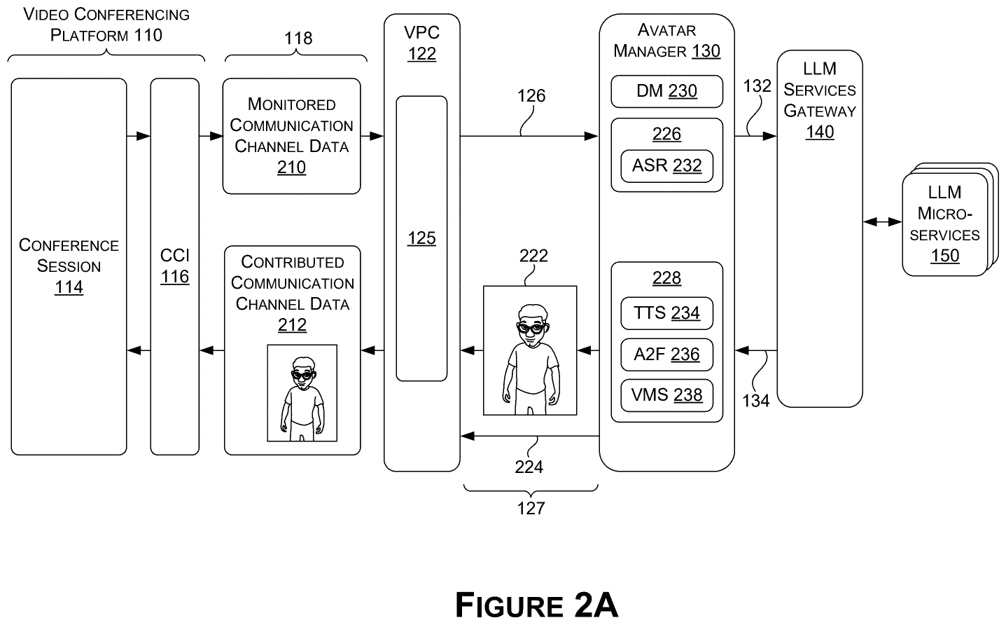

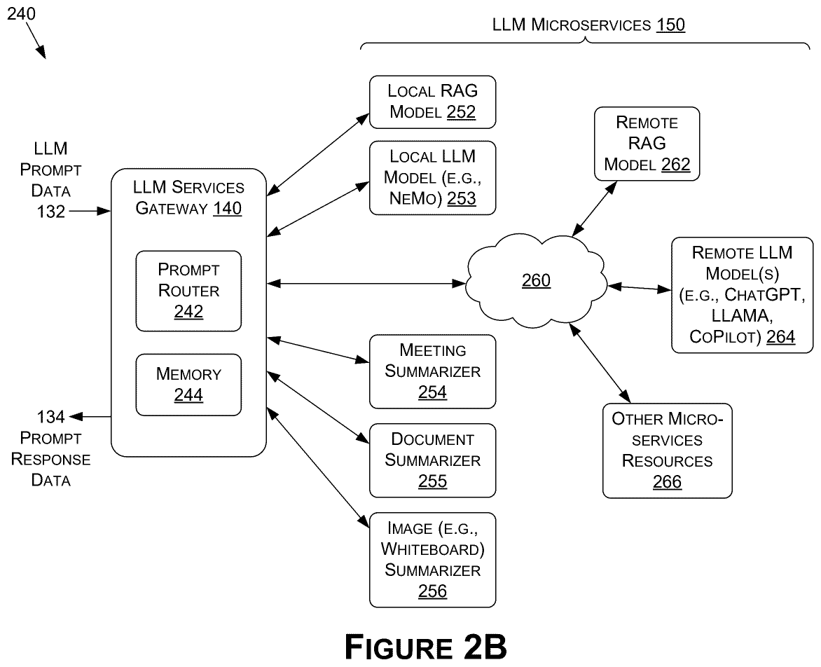

FIG. 2A is a diagram that further illustrates exemplary aspects of the avatar manager 130, according to some embodiments of the present disclosure. As shown in FIG. 2A, the VPC 122 and the CCI 116 establish a communication channel 118 through which the VPC 122 can communicate communication channel data that includes monitored communication channel data 210 (e.g., incoming communication channel data from user participants of the conference session 114) and contributed communication channel data 212 (e.g., outgoing communication channel data to be distributed to user participants from the conference session 114). The avatar manager 130 may comprise a first communication channel-processing path 226 to process the engagement data 126 into LLM prompt data 132, and a second communication channel-processing path 228 to generate VP response data 127 from prompt response data 134. As previously discussed, the avatar manager 130 may be implemented using an AI-based software framework (e.g., a suite of cloud-hosted AI models) such as, but not limited to, NVIDIA's Tokkio.

With respect to the monitored communication channel data 210, this data may be processed by the VP engagement function 125, which recognizes when the data comprises invocations and/or queries to be answered by the virtual participant. When the monitored communication channel data 210 does comprise invocations and/or one or more queries to be answered by the virtual participant, the VP engagement function 125 transmits engagement data 126 (representing the one or more queries) to the avatar manager 130. The engagement data 126 is received by the first communication channel-processing path 226, which may comprise a dialog manager (DM) 230 and automatic speech recognition (ASR) 232.

The DM 230 comprises algorithms and AI modes for natural language processing used to engage the human user participants of the conference session 114 in an interactive dialogue based on the exchange of engagement data 126 and VP response data 127. As an example, in some embodiments the DM 230 may be implemented using a Rasa dialog management framework. The ASR 232 may be implemented using a set of GPU-accelerated multilingual speech and translation microservices that include speech-to-text and neural machine translation services, such as but not limited to NVIDIA Riva. The engagement data 126 is processed using the DM 230 and ASR 232 (e.g., using natural language processing algorithms) to generate the LLM prompt data 132 that represents portions of the monitored communication channel data 210 comprising one or more queries to the virtual participant. The LLM prompt data 132 may be input to the LLM services gateway 140 to engage one or more of the LLM microservices 150 to generate one or more responses to the queries.

In some embodiments, LLM prompt data 132 is used to perform one or more LLM calls to the LLM services gateway 140, which results in the avatar manager 130 receiving prompt response data 134. As further discussed with respect to FIG. 2B, the prompt response data 134 may comprise responses generated by one or more of the LLM microservices 150 in response to the LLM prompt data 132. The prompt response data 134 may be received by the second communication channel-processing path 228 to generate the VP response data 127. As illustrated in FIG. 2A, the second communication channel-processing path 228 may include modules such as, but not limited to, text-to-speech (TTS) 234, audio-to-face (A2F) 236, and/or video management service (VMS) 238. In some embodiments, the prompt response data 134 may represent a textual response to the LLM prompt data 132 by one or more of the LLM microservices 150. The TTS 234 may comprise algorithms, an LLM, and/or AI natural language models to convert the prompt response data 134 into speech data (e.g., spoken audio) using an AI-generated voice. The TTS 234 generated speech data may then be provided as input to the A2F 236 to produce avatar data representing an animated 3D avatar of a person representing the virtual participant, whose lips, facial features, and/or other body movements are animated to match the voice-over track of the speech data. In some embodiments, the A2F 236 may comprise or be implemented using the NVIDIA Audio2Face facial animation generative AI-based algorithms. The avatar data, which may include both the animated image of the avatar and the corresponding spoken audio speech data, may be provided as input to the VMS 238 to render the avatar data as an animated avatar video stream 222 presented within the video conferencing environment associated with the conference session 114. That is, the animated avatar video stream 222 may define a component of the VP response data 127 that the VPC 122 transmits to the conference session 114 to provide a response to a query defined by the engagement data 126. In some embodiments, the presentation of the animated 3D avatar by the VMS 238 may be controlled by the DM 230, for example to respond to incoming requests for the virtual participant to pause or stop a presentation and/or to repeat a segment of the response. In some embodiments, at least a portion of the prompt response data 134 may be defined as text message data 224 that may represent a simulated text message response from the virtual participant. The text message data 224 may be delivered to the conference session 114 within a chat window of the video conference environment, in addition to or instead of using the animated avatar video stream 222. In some embodiments, the avatar manager 130 may determine when the prompt response data 134 should be conveyed to the conference session 114 using the animated avatar video stream 222 and/or the text message data 224 based on various criteria. For example, in some embodiments, the avatar manager 130 may evaluate the prompt response data 134 to determine a length of the response (e.g., how long it would take the animated avatar video stream 222 to deliver the response) and if the length exceeds a threshold, elect to deliver the response as text message data 224. In some such embodiments, the animated avatar video stream 222 may inform the user participants that the answer to the question is in the chat window. In other embodiments, the avatar manager 130 may elect to deliver the response at least in part as text message data 224 if the query was originally submitted by a user participant in the form of a text message to the virtual participant, or based on the nature of the request (e.g., results from summary requests may by default be presented back to the conference session 114 as text message data 224). Once the animated avatar video stream 222 and/or text message data 224 are received by the VP engagement function 125 of the VPC 122, they may be aggregated by the VP engagement function 125 to form the contributed communication channel data 212 and transmitted onto the conference session 114, as described herein.

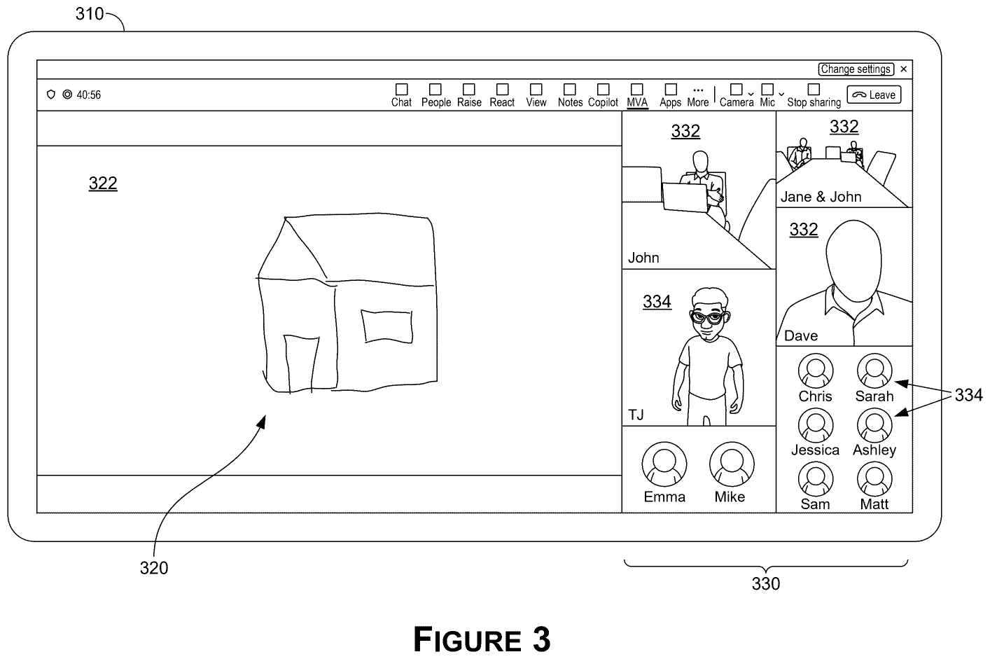

Referring now to FIG. 3, FIG. 3 is a diagram illustrating an example user interface (UI) 310 of a user participant client application 112 representing a video conferencing environment associated with the conference session 114. In this example UI 310, the video conferencing environment includes a primary presenter screen 320 (which in this example presents a shared whiteboard display 322), and a participants region 330 that displays the participants of the video conferencing environment. As described herein, the conference session 114 includes the logical infrastructure established by the video conferencing platform 110 to transport channel data in real time between the conference participants. In this example, a number of the user participants have elected to share their real-time local video feeds, so that those participants are presented in the participants region 330 as video using those real-time local video feeds, as shown by windows 332. Other user participants, represented by windows 334, have elected not to share real-time local video feeds and are instead presented in the participants region 330 using still profile images or default images. The virtual participant may also be represented in the participants region 330 using the animated avatar video stream 222 generated by the avatar manager 130, as shown at window 334. When the avatar manager 130 generates the animated avatar video stream 222 to present prompt response data 134, the rendering of the animated avatar video stream 222 may be presented in the window 334 assigned to the virtual participant and/or the primary presenter screen 320. In some embodiments, when the VP engine 120 is not actively processing queries to the virtual participant, the avatar manager 130 may generate an animated avatar video stream 222 representing an idle virtual participant, for example, a participant that is slightly swaying, blinking, and/or varying their gaze to simulate a virtual participant that is on standby awaiting requests.

FIG. 2B is a diagram that further illustrates exemplary aspects of a backend large language model (LLM) platform 240 of the VP engine 120, according to some embodiments of the present disclosure. As shown in FIG. 2B, the LLM platform 240 comprises LLM services gateway 140, which is coupled to the one or more LLM-based microservices 150. The LLM services gateway 140 of the VP engine 120 exposes access to the LLM-based microservices 150 as a service that may be performed through interactions with the virtual participant. LLM-based microservices 150 may include, but are not limited to, services that summarize, compile, critique, compare, or otherwise evaluate information from one or more data sources based on LLM prompt data 132.

In some embodiments, the LLM services gateway 140 may comprise a prompt router 242 that receives the LLM prompt data 132 and selects one or more of the LLM microservices 150 to call on to provide a response. The prompt router 242 may apply rule-based logic or other algorithms to evaluate the LLM prompt data 132 to select one or more of the LLM microservices 150, and then route the LLM prompt data 132 to those microservices. For example, LLM prompt data 132 comprising a request for a document summary may be routed to a document summarizer service, an LLM prompt data 132 comprising a query for an analysis based on authoritative knowledge data sources may be routed to a RAG model resource, an LLM prompt data 132 comprising a more generalized query may be routed to a general LLM model resource, and so forth.

As shown in FIG. 2B, the LLM microservices 150 exposed by the LLM services gateway 140 may include, but are not limited to, a local RAG model 252, a local LLM model 253, and summarizer services such as a meeting summarizer 254, a document summarizer 255, and/or an image summarizer 256. In some embodiments, the LLM microservices 150 may include remote (e.g., third-party)-provided services accessible to the LLM microservices 150 via a network 260 (e.g., the Internet). Such remote LLM microservices may include, for example, a remote RAG model 262, one or more remote LLM models 264, and or other microservice resources 266.

The LLM services gateway 140 and/or prompt router 242 may be configurable (e.g., by the VP configuration function 124 using control data 141) to specify which LLM models (e.g., NVIDIA NeMo, Meta Llama, OpenAI ChatGPT, etc.), RAG models (e.g., Chatlabs RAG, or other third-party RAG models), and/or other microservice resources 266 are used to generate responses used for response data 134. The responses from the LLM microservices 150 may be aggregated and/or otherwise synthesized together by the LLM services gateway 140 to form the prompt response data 134 that is provided to the avatar manager 130.

Also as shown in FIG. 2B, the LLM services gateway 140 may include a memory 244 to store data used by one or more of the LLM microservices 150 for generating responses. For example, one or more authoritative knowledge data sources, and/or network addresses for network-connected servers hosting authoritative knowledge data sources, may be stored to the memory 244 and accessed by one or more of the RAG models 252 and 262 when generating responses to LLM prompt data 132. Similarly, with respect to summarizing content, data used by the meeting summarizer 254, document summarizer 255, and/or image summarizer 256 may be uploaded to the memory 244 and accessed by those content summarizer microservices when called on to perform their respective content-summarizing functions.

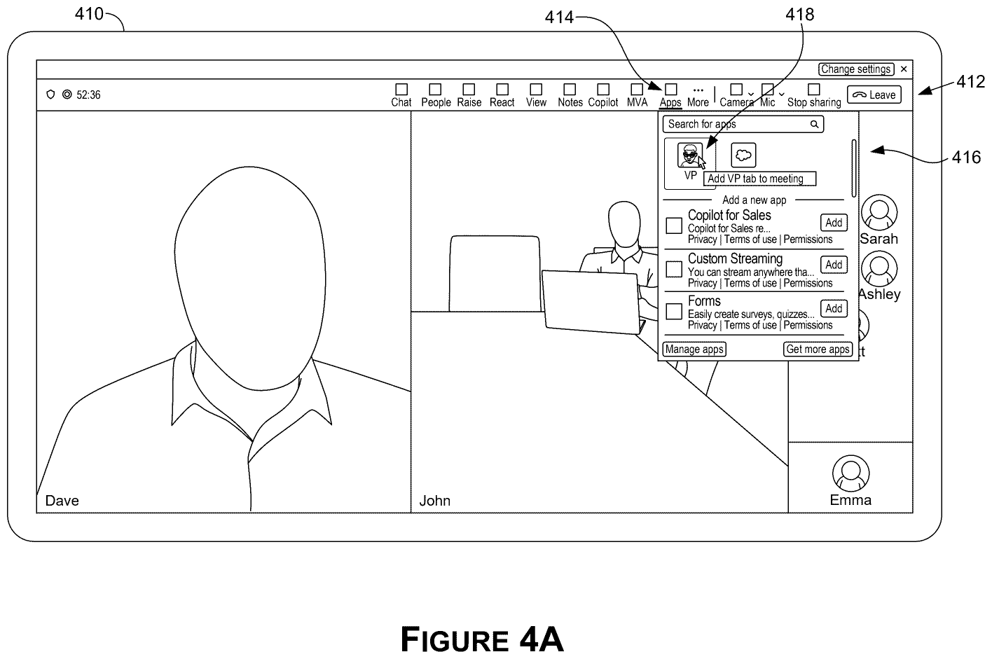

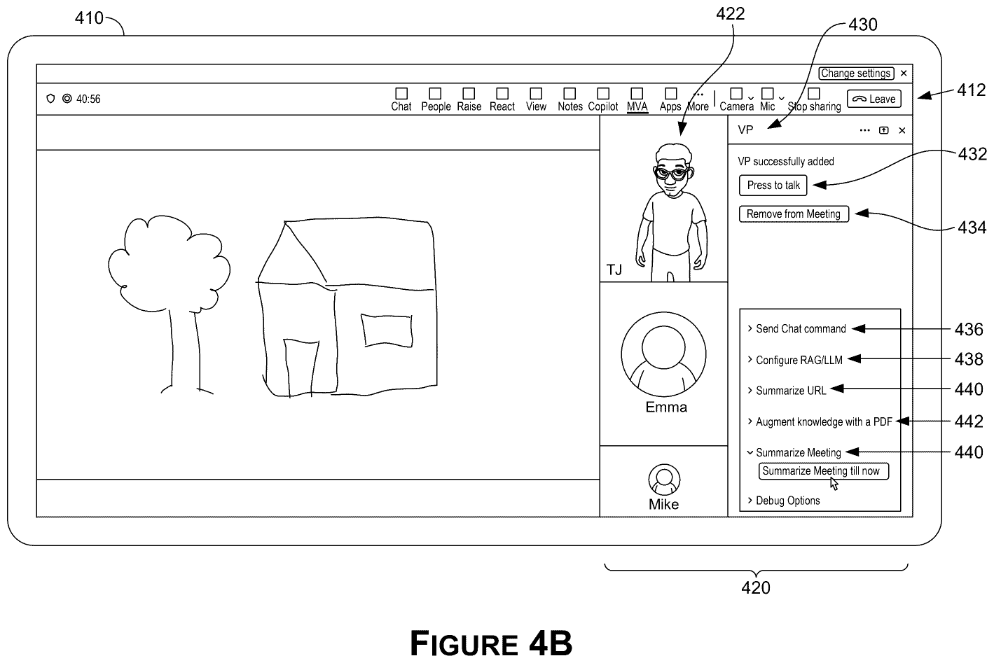

Referring now to FIGS. 4A and 4B, these figures illustrate example UIs, such as presented by a user participant client application 112, for activating, configuring, and/or using aspects of the virtual participant from within the video conferencing environment associated with the conference session 114. In this example, the UI 410 shown in FIG. 4A illustrates a process for activating the virtual participant, which may initiate establishing the communication channel between the CCI 116 and the VPC 122 of the VP engine 120. In the example, the UI 410 includes a toolbar 412 that includes at least one control feature 414 (e.g., a button) to open an application window 416 that displays optional plug-ins and/or applications, such as VP application 111, that may be activated within the video conferencing environment. In some embodiments, the application window 416 may include at least one selectable option (shown at 418) for activating the virtual participant discussed herein. Upon selection of the option 418 to activate the virtual participant, the video conferencing platform 110 may execute the VP application 111 to instantiate an instance of the CCI 116. The CCI 116 may then proceed to contact the VPC 122 (e.g., using a network address) and initiates a handshaking protocol to establish the communication channel 118 between the VPC 122 and CCI 116, and provide the VPC 122 with access to the conference session 114 in order to send and receive communication channel data, as discussed herein. As shown in FIG. 4B, the virtual participant may then be presented in the participants region 420 using the animated avatar video stream 222 generated by the avatar manager 130, as shown at window 422. In some embodiments, by selecting the avatar of the virtual participant, a user may open a virtual participant management window 430 for controlling one or more aspects of the virtual participant. For example, in FIG. 4B, the virtual participant management window 430 includes a “Press to Talk” control button 432 that operates as an invocation mechanism to trigger the VPC 122 to process incoming spoken audio data from the conference session 114. That is, VP engagement function 125 may detect that the “Press to Talk” control button 432 is activated, and based on that detection, begin generating engagement data 126 from the monitored communication channel data 210 received from the conference session 114. In some embodiments, the invocation mechanism may then be deactivated by the user by releasing the “Press to Talk” control button 432. In some embodiments, the “Press to Talk” control button 432 may act as a toggle so that the button is pressed to activate the invocation mechanism, and then pushed again to release the invocation mechanism. In some embodiments, the virtual participant management window 430 may include a control button 434 to deactivate and remove the virtual participant from the meeting, which may trigger the CCI 116 to communicate a virtual participant shutdown message to the VP configuration function 124. Based on the virtual participant shutdown message, the VP configuration function 124 may control the VPC to deactivate the communication channel 118, purge the memory 244, and/or otherwise reinitialize the VP engine 120 to a default configuration. In some embodiments, a chat or direct messages control 436 may be used as an invocation mechanism to trigger the VP engagement function 125 to generate engagement data 126 for a query provided as text in a direct message or in the chat window of the video conference environment. Another control may include a configuration control 438 that communicates configuration preferences to the VP configuration function 124. For example, in some embodiments, activating the configuration control 438 may open an interface indicating a selection of LLM and/or RAG resources exposed by (e.g., available through) the LLM services gateway 140, and the VP configuration function 124 may configure the LLM services gateway 140 to use LLM microservices 150 based on the selected resources. The virtual participant management window 430 may include one or more content summarization controls 440 that permit the user to obtain summaries, as discussed herein, of documents uploaded to the LLM services gateway 140, content from network data sources, images shared via the conference session 114, and/or a meeting summary, as discussed herein. In some embodiments, a knowledge augmentation control 442 may be used to upload to the LLM services gateway 140 authoritative knowledge data sources, and/or network addresses for network-connected servers hosting authoritative knowledge data sources, for use by one or more of the LLM microservices 150 (e.g., RAG models 252 and/or 262).

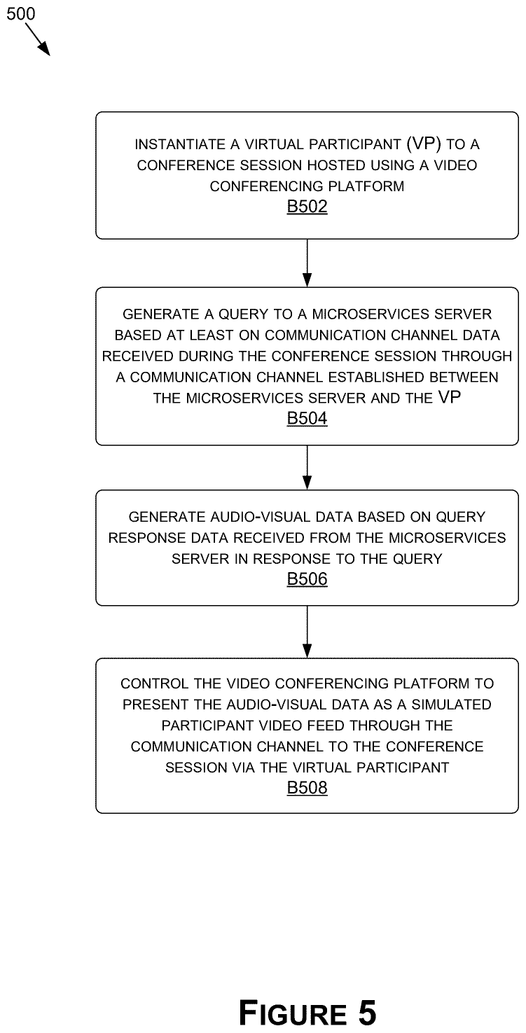

FIG. 5 is a diagram illustrating a method for a virtual participant service, in accordance with some embodiments of the present disclosure. It should be understood that the features and elements described herein with respect to the method 500 of FIG. 5 may be used in conjunction with, in combination with, or substituted for elements of any of the other embodiments discussed herein and vice versa. Further, it should be understood that the functions, structures, and other descriptions of elements for embodiments described in FIG. 5 may apply to like or similarly named or described elements across any of the figures and/or embodiments described herein and vice versa.

Each block of method 500, described herein, comprises a computing process that may be performed using any combination of hardware, firmware, and/or software. For instance, various functions may be carried out by one or more processors comprising processing circuitry and executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, method 500 is described, by way of example, with respect to the virtual participant service system 100 of FIG. 1. However, these methods may additionally or alternatively be executed by any one system, or any combination of systems, including, but not limited to, those described herein.

As discussed herein in greater detail, the method may include controlling a video conferencing platform to instantiate a virtual participant to a conference session; generating a query prompt to a microservices server (e.g., LLM services gateway 140) based at least on audio data received through a communication channel communicatively coupling the conference session with the microservices server; and presenting, to the conference session, audio-visual data comprising a virtual avatar associated with the virtual participant based at least on response data received from the microservices server in response to the query prompt.

The method 500, at block B502, includes instantiating a virtual participant (VP) to a conference session hosted using a video conferencing platform. In some embodiments, the method may including controlling a video conferencing platform to instantiate a virtual participant (VP) to a conference session hosted by the video conferencing platform, wherein the VP controller exchanges audio and video data during the conference session through the virtual participant. As previously discussed with respect to FIG. 1, a virtual participant service system may comprise a virtual participant (VP) engine that couples to a video conferencing platform and whose functions instantiate a virtual participant as a service that is accessible within the context of a video conferencing meeting hosted by the video conferencing platform. The video conferencing platform 110 may comprise a conferencing service such as, but not limited to, Microsoft Teams, Zoom, Cisco Webex, GoToMeeting, and the like. The VP engine may establish a communication channel with the conference session through a VP conference channel interface (CCI) provided by the video conferencing platform. In some embodiments, the video conferencing platform may execute a plug-in and/or other application (e.g., VP application 111) that establishes the CCI as an application programming interface (API) that provides access to the conference session, and a data link established with the conference session.

The method 500, at block B504, includes generating a query to a microservices server based at least on communication channel data received during the conference session through a communication channel established between the microservices server and the VP. In some embodiments, the method includes generating a query to a microservices server based at least on communication channel data received from the communication channel during the conference session. For example, as discussed with respect to FIGS. 2A and 2B, the VPC 122 and the CCI 116 may establish the communication channel 118 through which the VPC 122 can communicate communication channel data that includes monitored communication channel data 210 (e.g., incoming communication channel data from user participants of the conference session 114) and contributed communication channel data 212 (e.g., outgoing communication channel data to be distributed to user participants from the conference session 114). An avatar manager 130 may comprise a first communication channel-processing path 226 to process the engagement data 126 into LLM prompt data 132, and a second communication channel-processing path 228 to generate VP response data 127 from prompt response data 134. The avatar manager 130 processes engagement data 126, which may include audio and image feeds from the user participants on the conference session 114, to generate LLM prompt data 132, which may be used for making LLM calls to the LLM services gateway 140 (e.g., a microservices server) and prompt one or more responses from the LLM microservices 150.

The method 500, at block B506, includes generating audio-visual data based on query response data received from the microservices server in response to the query. In some embodiments, the method may include generating audio-visual data comprising an animated avatar based on query response data received from the microservices server in response to the query. In some embodiments, the method may generate one or more prompts that represent at least the query based on voice data, text data, and/or image data included in the communication channel data. In some embodiments, the method may generate one or more prompts that represent at least the query based at least on voice data received as input during the conference session, and access one or more machine learning model-based services of the microservices server using the one or more prompts, wherein the query response data comprises a response generated based at least on the one or more machine learning model-based services. For example, as discussed with respect to FIG. 1 and FIG. 2A in some embodiments, LLM prompt data 132 is used to perform one or more LLM calls to the LLM services gateway 140, which results in the avatar manager 130 receiving prompt response data 134. As further discussed with respect to FIG. 2B, the prompt response data 134 may comprise responses generated by one or more of the LLM microservices 150 in response to the LLM prompt data 132. The prompt response data 134 may represent a textual response to the LLM prompt data 132 by one or more of the LLM microservices 150. A TTS 234 of the avatar manager 130 may comprise algorithms, an LLM, and/or AI natural language models to convert the prompt response data 134 into speech data (e.g., spoken audio) using an AI-generated voice. TTS 234 generated speech data may then be provided as input to the A2F 236 to produce avatar data representing an animated 3D avatar of a person representing the virtual participant, whose lips, facial features, and/or other body movements are generated to match the voice-over track of the speech data. The avatar data, which may include both the animated image of the avatar and the corresponding spoken audio speech data, may be provided as input to the VMS 238 to render the avatar data as an animated avatar video stream 222.

In some embodiments, the microservices server may be controlled based at least on the query to generate a summarization in response to the communication channel data received from the communication channel, wherein the summarization comprises at least one of: a document summary of one or more documents submitted to the microservices server; a meeting summary of audio communications between user participants of the communication channel based on the communication channel data; a whiteboard content summary of a whiteboard presentation represented by the communication channel data; an image summary based on one or more images shared between user participants of the conference session through the communication channel; a video summary based on one or more videos shared between user participants of the conference session through the communication channel; and/or another type of content summarization. The method may control the microservices server to generate the query response data based on submitting a representation of the query as a prompt to a large language model (LLM), and/or submitting a representation of the query as a prompt to a retrieval-augmented generation (RAG) large language model (LLM) based at least on one or more augmentation data sources associated with the conference session. The one or more augmentation data sources may comprise at least one of: one or more documents uploaded to the RAG LLM during the conference session and/or through the communication channel, and one or more documents available from a network address provided during the conference session. In some embodiments, the method may include aggregating, using a natural language processing (NLP) large language model (LLM), a plurality of responses received in response to the query into a coherent response to form the query response data.

The method 500, at block B508, includes controlling the video conferencing platform to present the audio-visual data as a simulated participant video feed through the communication channel to the conference session via the virtual participant. In some embodiments, the method may include controlling the video conferencing platform to present the audio-visual data as a simulated participant video feed to the conference session via the virtual participant using the communication channel. In some embodiments, the animated avatar video stream 222 is presented within the video conferencing environment associated with the conference session 114. The animated avatar video stream 222 may define a component of the VP response data 127 that the VPC 122 transmits to the conference session 114 to provide a response to a query defined by the engagement data 126. A presentation of the audio-visual data during the conference session may be controlled based at least on audio data received from the communication channel. For example, in some embodiments, the presentation of the animated 3D avatar by the VMS 238 may be controlled by the DM 230, for example to respond to incoming requests for the virtual participant to pause or stop a presentation and/or to repeat a segment of the response. The video conferencing platform may be controlled to present at least a portion of the query response data as text data in a chat window user interface. For example, in some embodiments, at least a portion of the prompt response data 134 may be defined as text message data 224 that may represent a simulated text message response from the virtual participant.

In some embodiments, the method may include generating a user interface for display by the video conferencing platform, and adjusting a configuration of microservices exposed by the microservices server based on one or more user inputs to the user interface, such as described with respect to FIGS. 4A and 4B and elsewhere herein.

In some embodiments, the systems and methods described herein may be performed within, or in conjunction with, a simulation environment using simulated data (e.g., simulated sensor data of simulated sensors of a virtual or simulated machine). In some embodiments, the simulation environment and/or one or more objects, features, or components thereof, such as the simulated meeting participant, may be generated or managed within a three-dimensional (3D) content collaboration platform (e.g., NVIDIA's Omniverse) for industrial digitalization, generative physical artificial intelligence (AI), and/or other use cases, applications, or services. For example, the content collaboration platform or system may include a system for using or developing universal scene descriptor (USD) (e.g., OpenUSD) data for managing the simulated meeting participant and/or objects, features, scenes, etc., within a simulated environment, digital environment, etc. The platform may include real physics simulation, such as using NVIDIA's PhysX SDK, in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, or testing AI systems-such as systems for testing, validating, training (e.g., machine learning models, neural networks, etc.), and/or other tasks related to automotive, robot, machine, or other applications.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing, generative AI, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models-such as one or more large language models (LLMs) and/or one or more vision language models (VLMs), systems for performing light transport simulation, systems for performing collaborative content creation for 3D assets, systems implemented at least partially using cloud computing resources, and/or other types of systems.

### Example Computing Device

FIG. 6 is a block diagram of an example computing device(s) 600 suitable for use in implementing some embodiments of the present disclosure. In some embodiments, one or more elements of the VP engine 120, Video Conferencing Platform 110 and/or user participant client applications 112 may be performed using one or more of computing device(s) 200. Computing device 600 may include an interconnect system 602 that directly or indirectly couples the following devices: memory 604, one or more central processing units (CPUs) 606, one or more graphics processing units (GPUs) 608, a communication interface 610, input/output (I/O) ports 612, input/output components 614, a power supply 616, one or more presentation components 618 (e.g., display(s)), and one or more logic units 620. In at least one embodiment, the computing device(s) 600 may comprise one or more virtual machines (VMs), and/or any of the components thereof may comprise virtual components (e.g., virtual hardware components). For non-limiting examples, one or more of the GPUs 608 may comprise one or more vGPUs, one or more of the CPUs 606 may comprise one or more vCPUs, and/or one or more of the logic units 620 may comprise one or more virtual logic units. As such, a computing device(s) 600 may include discrete components (e.g., a full GPU dedicated to the computing device 600), virtual components (e.g., a portion of a GPU dedicated to the computing device 600), or a combination thereof.

Although the various blocks of FIG. 6 are shown as connected via the interconnect system 602 with lines, this is not intended to be limiting and is for clarity only. For example, in some embodiments, a presentation component 618, such as a display device, may be considered an I/O component 614 (e.g., if the display is a touch screen). As another example, the CPUs 606 and/or GPUs 608 may include memory (e.g., the memory 604 may be representative of a storage device in addition to the memory of the GPUs 608, the CPUs 606, and/or other components). As such, the computing device of FIG. 6 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 6.

The interconnect system 602 may represent one or more links or busses, such as an address bus, a data bus, a control bus, or a combination thereof. The interconnect system 602 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 606 may be directly connected to the memory 604. Further, the CPU 606 may be directly connected to the GPU 608. Where there is direct, or point-to-point connection between components, the interconnect system 602 may include a PCIe link to carry out the connection. In these examples, a PCI bus need not be included in the computing device 600.

The memory 604 may include any of a variety of computer-readable media. The computer-readable media may be any available media that may be accessed by the computing device 600. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 604 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 600. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 606 may be configured to execute at least some of the computer-readable instructions to control one or more components of the computing device 600 to perform one or more of the methods and/or processes described herein. The CPU(s) 606 may each include one or more cores (e.g., one, two, four, eight, twenty-eight, seventy-two, etc.) that are capable of handling a multitude of software threads simultaneously. The CPU(s) 606 may include any type of processor, and may include different types of processors depending on the type of computing device 600 implemented (e.g., processors with fewer cores for mobile devices and processors with more cores for servers). For example, depending on the type of computing device 600, the processor may be an Advanced RISC Machines (ARM) processor implemented using Reduced Instruction Set Computing (RISC) or an x86 processor implemented using Complex Instruction Set Computing (CISC). The computing device 600 may include one or more CPUs 606 in addition to one or more microprocessors or supplementary co-processors, such as math co-processors.

In addition to or alternatively from the CPU(s) 606, the GPU(s) 608 may be configured to execute at least some of the computer-readable instructions to control one or more components of the computing device 600 to perform one or more of the methods and/or processes described herein. One or more of the GPU(s) 608 may be an integrated GPU (e.g., with one or more of the CPU(s) 606 and/or one or more of the GPU(s) 608 may be a discrete GPU. In embodiments, one or more of the GPU(s) 608 may be a coprocessor of one or more of the CPU(s) 606. The GPU(s) 608 may be used by the computing device 600 to render graphics (e.g., 3D graphics) or perform general purpose computations. For example, the GPU(s) 608 may be used for General-Purpose computing on GPUs (GPGPU). The GPU(s) 608 may include hundreds or thousands of cores that are capable of handling hundreds or thousands of software threads simultaneously. The GPU(s) 608 may generate pixel data for output images in response to rendering commands (e.g., rendering commands from the CPU(s) 606 received via a host interface). The GPU(s) 608 may include graphics memory, such as display memory, for storing pixel data or any other suitable data, such as GPGPU data. The display memory may be included as part of the memory 604. The GPU(s) 608 may include two or more GPUs operating in parallel (e.g., via a link). The link may directly connect the GPUs (e.g., using NVLINK) or may connect the GPUs through a switch (e.g., using NVSwitch). When combined together, each GPU 608 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 606 and/or the GPU(s) 608, the logic unit(s) 620 may be configured to execute at least some of the computer-readable instructions to control one or more components of the computing device 600 to perform one or more of the methods and/or processes described herein. In embodiments, the CPU(s) 606, the GPU(s) 608, and/or the logic unit(s) 620 may discretely or jointly perform any combination of the methods, processes and/or portions thereof. One or more of the logic units 620 may be part of and/or integrated in one or more of the CPU(s) 606 and/or the GPU(s) 608 and/or one or more of the logic units 620 may be discrete components or otherwise external to the CPU(s) 606 and/or the GPU(s) 608. In embodiments, one or more of the logic units 620 may be a coprocessor of one or more of the CPU(s) 606 and/or one or more of the GPU(s) 608.

Examples of the logic unit(s) 620 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

In various embodiments, one or more elements of the VP engine 120, video conferencing platform 110 and/or user participant client applications 112 may be performed using one or more of the CPU(s) 606 and/or the GPU(s) 608, the logic unit(s) 620. In some embodiments, machine learning and LLM models of the VP engine 120 described herein may be executed by neural networks implemented using the CPU(s) 606 and/or the GPU(s) 608, the logic unit(s) 620.

The communication interface 610 may include one or more receivers, transmitters, and/or transceivers that allow the computing device 600 to communicate with other computing devices via an electronic communication network, included wired and/or wireless communications. The communication interface 610 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 620 and/or communication interface 610 may include one or more data processing units (DPUs) to transmit data received over a network and/or through interconnect system 602 directly to (e.g., a memory of) one or more GPU(s) 608.

The I/O ports 612 may allow the computing device 600 to be logically coupled to other devices including the I/O components 614, the presentation component(s) 618, and/or other components, some of which may be built in to (e.g., integrated in) the computing device 600. Illustrative I/O components 614 include a microphone, mouse, keyboard, joystick, game pad, game controller, satellite dish, scanner, printer, wireless device, etc. The I/O components 614 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 600. The computing device 600 may be include depth cameras, such as stereoscopic camera systems, infrared camera systems, RGB camera systems, touchscreen technology, and combinations of these, for gesture detection and recognition. Additionally, the computing device 600 may include accelerometers or gyroscopes (e.g., as part of an inertia measurement unit (IMU)) that allow detection of motion. In some examples, the output of the accelerometers or gyroscopes may be used by the computing device 600 to render immersive augmented reality or virtual reality.

The power supply 616 may include a hard-wired power supply, a battery power supply, or a combination thereof. The power supply 616 may provide power to the computing device 600 to allow the components of the computing device 600 to operate.

The presentation component(s) 618 may include a display (e.g., a monitor, a touch screen, a television screen, a heads-up-display (HUD), other display types, or a combination thereof), speakers, and/or other presentation components. The presentation component(s) 618 may receive data from other components (e.g., the GPU(s) 608, the CPU(s) 606, DPUs, etc.), and output the data (e.g., as an image, video, sound, etc.). In some embodiments, user interfaces such as described herein may be rendered on one or more displays of the presentation component(s) 618.

### Example Data Center

FIG. 7 illustrates an example data center 700 that may be used in at least one embodiments of the present disclosure. The data center 700 may include a data center infrastructure layer 710, a framework layer 720, a software layer 730, and/or an application layer 740. In various embodiments, one or more elements of the VP engine 120, video conferencing platform 110 and/or user participant client applications 112 may be performed using the data center 700.

As shown in FIG. 7, the data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 716(1)-716(N) may correspond to a server having one or more of the above-mentioned computing resources. In addition, in some embodiments, the node C.R.s 716(1)-7161(N) may include one or more virtual components, such as vGPUs, vCPUs, and/or the like, and/or one or more of the node C.R.s 716(1)-716(N) may correspond to a virtual machine (VM). One or more elements of the VP engine 120, video conferencing platform 110 and/or user participant client applications 112 may be performed using code executed by one or more of the node C.R.s 716(1)-716(N).

In at least one embodiment, grouped computing resources 714 may include separate groupings of node C.R.s 716 housed within one or more racks (not shown), or many racks housed in data centers at various geographical locations (also not shown). Separate groupings of node C.R.s 716 within grouped computing resources 714 may include grouped compute, network, memory or storage resources that may be configured or allocated to support one or more workloads. In at least one embodiment, several node C.R.s 716 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 712 may configure or otherwise control one or more node C.R.s 716(1)-716(N) and/or grouped computing resources 714. In at least one embodiment, resource orchestrator 712 may include a software design infrastructure (SDI) management entity for the data center 700. The resource orchestrator 712 may include hardware, software, or some combination thereof.

In at least one embodiment, as shown in FIG. 7, framework layer 720 may include a job scheduler 728, a configuration manager 734, a resource manager 736, and/or a distributed file system 738. The framework layer 720 may include a framework to support software 732 of software layer 730 and/or one or more application(s) 742 of application layer 740. The software 732 or application(s) 742 may respectively include web-based service software or applications, such as those provided by Amazon Web Services, Google Cloud and Microsoft Azure.

The framework layer 720 may be, but is not limited to, a type of free and open-source software web application framework such as Apache Spark™ (hereinafter “Spark”) that may use distributed file system 738 for large-scale data processing (e.g., “big data”). In at least one embodiment, job scheduler 728 may include a Spark driver to facilitate scheduling of workloads supported by various layers of data center 700. The configuration manager 734 may be capable of configuring different layers such as software layer 730 and framework layer 720 including Spark and distributed file system 738 for supporting large-scale data processing. The resource manager 736 may be capable of managing clustered or grouped computing resources mapped to or allocated for support of distributed file system 738 and job scheduler 728. In at least one embodiment, clustered or grouped computing resources may include grouped computing resource 714 at data center infrastructure layer 710. The resource manager 736 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 738 of framework layer 720. One or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 738 of framework layer 720. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments. In some embodiment, one or more functions of the VP engine 120 and/or video conferencing platform 110 described herein may be implemented using one or more of the application(s) 742.

In at least one embodiment, any of configuration manager 734, resource manager 736, and resource orchestrator 712 may implement any number and type of self-modifying actions based on any amount and type of data acquired in any technically feasible fashion. Self-modifying actions may relieve a data center operator of data center 700 from making possibly bad configuration decisions and possibly avoiding underutilized and/or poor performing portions of a data center.

The data center 700 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 700. In at least one embodiment, trained or deployed machine learning models corresponding to one or more neural networks may be used to infer or predict information using resources described above with respect to the data center 700 by using weight parameters calculated through one or more training techniques, such as but not limited to those described herein.

In at least one embodiment, the data center 700 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 600 of FIG. 6—e.g., each device may include similar components, features, and/or functionality of the computing device(s) 600. In addition, where backend devices (e.g., servers, NAS, etc.) are implemented, the backend devices may be included as part of a data center 700, an example of which is described in more detail herein with respect to FIG. 7.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 600 described herein with respect to FIG. 6. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising processing circuitry to:
instantiate a virtual participant (VP) to a conference session hosted using a video conferencing platform;
generate a query to a microservices server based at least on communication channel data received during the conference session through a communication channel established between the microservices server and the VP;
generate audio-visual data based on query response data received from the microservices server in response to the query; and
control the video conferencing platform to present the audio-visual data as a simulated participant video feed through the communication channel to the conference session via the virtual participant.

2. The one or more processors of claim 1, wherein the one or more processors are further to:
generate one or more prompts that represent at least the query based at least on voice data received as input during the conference session; and
access one or more machine learning model-based services of the microservices server using the one or more prompts, wherein the query response data comprises a response generated based at least on the one or more machine learning model-based services.

3. The one or more processors of claim 1, wherein the one or more processors are further to:
generate one or more prompts that represent at least the query based at least on text data received as input during the conference session; and
access one or more machine learning model-based services of the microservices server using the one or more prompts, wherein the query response data comprises a response generated based at least on the one or more machine learning model-based services.

4. The one or more processors of claim 1, wherein the one or more processors are further to:
generate one or more prompts that represent at least the query based at least on image data received as input during the conference session; and
access one or more machine learning model-based services of the microservices server using the one or more prompts, wherein the query response data comprises a response generated based at least on the one or more machine learning model-based services.

5. The one or more processors of claim 1, wherein the one or more processors are further to:
control the microservices server based at least on the query to generate a summarization in response to the communication channel data received during the conference session and from the communication channel, wherein the summarization comprises at least one of:
a document summary of one or more documents submitted to the microservices server;
a meeting summary of audio communications between user participants of the conference session based on the communication channel data;
a whiteboard content summary of a whiteboard presentation represented by the communication channel data;
an image summary based on one or more images shared between user participants of the conference session through the communication channel; and
a video summary based on one or more videos shared between user participants of the conference session through the communication channel.

6. The one or more processors of claim 1, wherein the one or more processors are further to:
control the microservices server to generate the query response data based on submitting a representation of the query as a prompt to a large language model (LLM).

7. The one or more processors of claim 1, wherein the one or more processors are further to:
control the microservices server to generate the query response data based on submitting a representation of the query as a prompt to a retrieval-augmented generation (RAG) large language model (LLM) based at least on one or more augmentation data sources associated with the conference session.

8. The one or more processors of claim 7, wherein the one or more augmentation data sources comprise at least one of: one or more documents uploaded to the RAG LLM through the communication channel, and one or more documents available from a network address provided during the conference session.

9. The one or more processors of claim 1, wherein the one or more processors are further to:
aggregate, using a natural language processing (NLP) large language model (LLM), a plurality of responses received in response to the query to form the query response data.

10. The one or more processors of claim 1, wherein the one or more processors are further to:
process the query response data using a text-to-speech (TTS) module to convert the query response data into spoken audio data using an artificial intelligence (AI) model-generated voice;
process the spoken audio data using an audio-to-face (A2F) AI model-based module to generate animated avatar data, wherein the animated avatar data comprises animated facial features that correspond at least to the spoken audio data; and
convert the animated avatar data into the audio-visual data comprising an animated avatar.

11. The one or more processors of claim 1, wherein the one or more processors are further to:
control a presentation of the audio-visual data transmitted over the communication channel based at least on audio data received during the conference session.

12. The one or more processors of claim 1, wherein the one or more processors are further to:
control the video conferencing platform to present at least a portion of the query response data as text data in a chat window user interface.

13. The one or more processors of claim 1, wherein the one or more processors are further to:
monitor the communication channel data received using the communication channel during the conference session to detect an invocation mechanism; and
generate the query to the microservices server in response to detection of the invocation mechanism.

14. The one or more processors of claim 1, wherein the one or more processors are further to:
generate a user interface for display by the video conferencing platform; and
adjust a configuration of microservices exposed by the microservices server based on one or more user inputs to the user interface.

15. The one or more processors of claim 1, wherein the processing circuitry is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for three-dimensional assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.

16. A system comprising one or more processors to:
transmit a query to a microservices server, the query generated based at least on first communication channel data received through a communication channel with an instantiated conference session of a video conferencing platform;
generate second communication channel data comprising an avatar based on query response data received from the microservices server in response to the query; and
control the video conferencing platform to present the second communication channel data to the conference session as a simulated participant video feed of a virtual participant.

17. The system of claim 16, wherein the one or more processors are further to
generate one or more prompts that represent at least the query based on data included in the communication channel data that comprises one or more of voice data, text data, and image data; and
access one or more machine learning model-based services of the microservices server using the one or more prompts, wherein the query response data comprises a response generated based at least on the one or more machine learning model-based services.

18. The system of claim 16, wherein the one or more processors are further to:
process the query response data using text-to-speech (TTS) to convert the query response data into spoken audio data using an artificial intelligence (AI) model-generated voice;
process the spoken audio data using an audio-to-face (A2F) AI model to generate avatar data, wherein the avatar data comprises the avatar of the virtual participant that includes one or more animated facial features that correspond at least to the spoken audio data; and
convert the avatar data into the communication channel data for presentation as the simulated participant video feed.

19. The system of claim 16, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for three-dimensional assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.

20. A method comprising:
controlling a video conferencing platform to instantiate a virtual participant to a conference session;
generating a query prompt to a microservices server based at least on audio data received through a communication channel communicatively coupling the conference session with the microservices server; and
presenting, to the conference session, audio-visual data comprising a virtual avatar associated with the virtual participant based at least on response data received from the microservices server in response to the query prompt.
